(19) United States
(12) Patent Application Publication
(10) Pub. No.: US 2020/0279180 A1
(43) Pub. Date: Sep. 3, 2020

(54) ARTIFICIAL INTELLIGENCE CUSTOMER SUPPORT CASE MANAGEMENT SYSTEM

(71) Applicants: Mengjie Yu, Folsom, CA (US); Lawrence K. Fraser, Shingle Springs, CA (US); Can Cui, San Jose, CA (US); Ronald J. Raymond, Sacramento, CA (US); Jennifer L. Middlekauff, Fair Oaks, CA (US); Patrick Liam Yates, Rancho Cordova, CA (US); Oliver Wu Chen, El Dorado Hills, CA (US); Stephen E. Nicol, Spencer, MA (US); Johnny R. Cutright, Gaston, OR (US); Shebin Kurian, Kerala (IN); Anaha R. Atri, Bangalore (IN); Satrajit Maitra, Kolkata (IN); Anitha Selvaraj, Bangalore (IN)

(72) Inventors: Mengjie Yu, Folsom, CA (US); Lawrence K. Fraser, Shingle Springs, CA (US); Can Cui, San Jose, CA (US); Ronald J. Raymond, Sacramento, CA (US); Jennifer L. Middlekauff, Fair Oaks, CA (US); Patrick Liam Yates, Rancho Cordova, CA (US); Oliver Wu Chen, El Dorado Hills, CA (US); Stephen E. Nicol, Spencer, MA (US); Johnny R. Cutright, Gaston, OR (US); Shebin Kurian, Kerala (IN); Anaha R. Atri, Bangalore (IN); Satrajit Maitra, Kolkata (IN); Anitha Selvaraj, Bangalore (IN)

(21) Appl. No.: 16/877,063

(22) Filed: May 18, 2020

Related U.S. Application Data
(60) Provisional application No. 62/849,771, filed on May 17, 2019.

(51) Int. Cl. G06N 5/04; G06Q 30/00; G06N 20/00

(52) U.S. Cl. CPC G06N 5/04; G06N 20/00; G06Q 30/016

(57) ABSTRACT

In one embodiment, a computing device includes processing circuitry to predict outcomes of unresolved customer support cases. For example, the processing circuitry: receives a request to predict an outcome of an unresolved customer support case; extracts a set of features from a case record for the unresolved case, including a set of categorical features and a set of textual features; encodes the set of categorical and textual features into numerical representations; predicts the outcome of the unresolved customer support case using a trained case prediction model, wherein the trained case prediction model generates a predicted outcome based on the encoded categorical and textual features; and performs a corresponding customer support action based on the predicted outcome of the unresolved customer support case.

### CROSS-REFERENCE TO RELATED APPLICATIONS

This patent application claims the benefit of the filing date of U.S. Provisional Patent Application Ser. No. 62/849,771, filed on May 17, 2019, and entitled “PREDICTIVELY RESOLVING CUSTOMER SUPPORT CASES USING ARTIFICIAL INTELLIGENCE,” the contents of which are hereby expressly incorporated by reference.

### FIELD OF THE SPECIFICATION

This disclosure relates in general to the field of customer relationship management (CRM) systems, and more particularly, though not exclusively, to predictively managing customer support cases using artificial intelligence.

### BACKGROUND

Enterprise customer support teams and their customers spend a significant amount of time manually troubleshooting customer support cases that ultimately cannot be resolved through traditional methods. For example, human-based customer support is extremely labor intensive, and many customer support cases simply cannot be resolved through manual troubleshooting. As a result, existing customer support methods require increasingly complex (e.g., time-consuming and labor-intensive) interactions with customers that may ultimately be futile.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example embodiment of an artificial intelligence (AI) customer support case management system.

FIG. 2 illustrates an example of model training on an AI customer support case management system.

FIG. 3 illustrates an example of model deployment and integration on an AI customer support case management system.

FIG. 4 illustrates an example of model inference on an AI customer support case management system.

FIG. 5A illustrates a flowchart for predictively resolving customer support cases using artificial intelligence.

FIG. 5B illustrates a flowchart for predicting customer satisfaction for customer support cases using artificial intelligence.

FIG. 5C illustrates a flowchart for predicting fraudulent customer support cases using artificial intelligence.

FIG. 6 illustrates an example computing platform in accordance with various embodiments.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Artificial Intelligence Customer Support Case Management System

Enterprise customer support teams and their customers spend a significant amount of time manually troubleshooting customer support cases that ultimately cannot be resolved through traditional solutions, such as rule-based expert systems, live customer support agents, chatbots, and so forth. For example, business application suite vendors often integrate rule-based expert systems into their suite of products to specify business logic that facilitates troubleshooting of customer support cases by customers and/or customer support agents. Artificial intelligence (AI) customer support agents (e.g., chatbots) can also be used, but they typically provide lower-level support and still require human intervention. Human-based customer support is extremely labor intensive, however, and many customer support cases simply cannot be resolved through manual troubleshooting. As a result, existing customer support solutions require increasingly complex (e.g., time-consuming and labor-intensive) interactions with customers that may ultimately be futile.

Accordingly, this disclosure presents various embodiments of an automated customer support system that leverages artificial intelligence (AI) and/or machine learning (ML) to predictively resolve customer support cases. For example, this solution proactively identifies customer support cases that will likely be unresolvable using traditional customer support methods (e.g., live support and/or manual troubleshooting), which allows those traditional customer support methods to be bypassed so that alternative resolutions and/or outcomes can be offered to customers much faster. Upon determining that traditional customer support methods will be ineffective, for example, customers can be offered non-troubleshooting alternatives, such as replacing or repairing products under warranty, dispatching on-site technicians, and so forth.

Moreover, this solution can also be leveraged for a variety of other use cases, including fraud detection and predictive customer satisfaction, among others. With respect to fraud detection, this solution can proactively identify anomalous customer support cases that are potentially fraudulent (e.g., fraudulent warranty claims) using AI. With respect to predictive customer satisfaction, this solution can predict the likelihood that customers are satisfied with the support they received for their respective customer support cases using AI. For example, a machine learning model can be trained to predict customer satisfaction based on historical case records and customer survey responses indicating the actual “ground truth” customer satisfaction levels in those cases. In some embodiments, for example, the “ground truth” customer satisfaction levels for past cases may be determined from customer surveys and/or other customer/case data indicating customer satisfaction ratings (e.g., CES scores or other satisfaction ratings such as a 1-10 rating), whether the customers plan to purchase the product again in the future, whether the customers have or would recommend the product to others (e.g., business colleagues, business partners, friends and family, and/or other third parties), whether the customers continued or terminated the business relationship, and so forth.

In general, this solution showcases how traditional business application suites can leverage artificial intelligence and machine learning to enable expert systems to reach optimal resolutions much faster across a variety of use cases, including consumer chatbots and/or interactive product support, insurance claim processing, health care diagnosis and patient care, and industrial predictive maintenance, among other examples.

Moreover, this solution can be implemented on computing platforms with or without hardware acceleration (e.g., on CPUs by themselves or CPU/FPGA architectures with AI hardware acceleration), thus rendering it suitable for both low-end and high-end computing environments, including edge deployments (e.g., on-premise hosted datacenters) and cloud deployments (e.g., cloud service provider (CSP) datacenters).

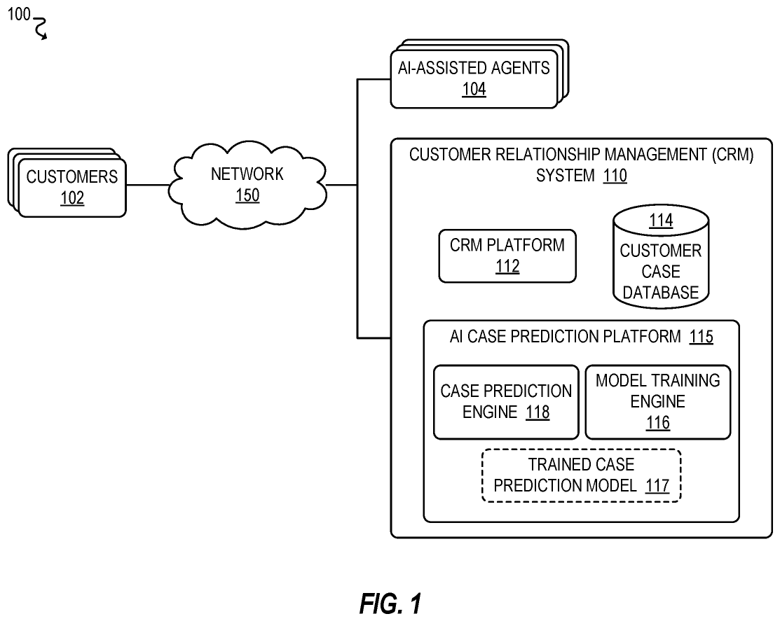

FIG. 1 illustrates an example embodiment of an artificial intelligence (AI) customer support case management system 100. In the illustrated embodiment, for example, system 100 includes customers 102, artificial intelligence (AI) assisted agents 104, a customer relationship management (CRM) system 110, and a communication network 150. The customers 102 are connected with the AI-assisted agents 104 (e.g., live agents or chatbots) over the communication network 150 to receive customer support, which is provided by the agents 104 with assistance from the CRM system 110. As described further below, for example, the CRM system 110 leverages artificial intelligence (AI) and machine learning (ML) techniques to predictively manage and/or resolve certain customer support cases.

Customer service is widely applied in every industry. For example, a business that sells products and/or services typically has a customer support team that provides support to customers in connection with those products and services, such as technical troubleshooting, warranty returns/replacements, and so forth. A business often measures the success of its customer support using the industry standard customer feedback metric known as the customer effort satisfaction (CES) score, which measures how happy customers are with the level of effort that they needed to expend in order to have their issues resolved.

Moreover, when a customer 102 contacts a business's customer support team for help with a particular product (e.g., an electronic device), the customer 102 can be connected to a customer support agent 104 at one of many locations around the world. Business policies often require that the support agent 104 attempt to resolve the product issue with the customer 102 through technical troubleshooting before the product can be returned, replaced, and/or repaired through the warranty, which increases the level of effort expended by the customer 102 to resolve the issue. If the customer support case ultimately results in a warranty return, the customer effort satisfaction (CES) score for that customer 102 will be negatively impacted (e.g., between 2% and 4%) due to the time wasted on troubleshooting. Further, when support agents 104 spend time troubleshooting cases that ultimately result in warranty returns, their attention is pulled away from other cases that actually can be resolved through technical troubleshooting. This results in longer overall throughput times (TPT) for those cases, which similarly has a negative impact on the CES scores of the customers 102 associated with those cases (e.g., up to 10%).

Accordingly, in the illustrated embodiment, the CRM system 110 is implemented with functionality that uses various types of customer support data to enable customer support teams to make faster and smarter decisions, with the goal of decreasing the customer support case throughput time (TPT) and increasing the customer effort satisfaction (CES) rate.

In the illustrated embodiment, for example, the CRM system 110 leverages artificial intelligence (AI) and machine learning (ML) to predictively manage and/or resolve certain customer support cases. For example, the CRM system 110 leverages artificial intelligence (AI) and machine learning (ML) to proactively identify customer support cases that will likely be unresolvable through live support and/or manual troubleshooting, which allows those types of customer support to be bypassed in favor of alternative resolutions and/or outcomes. In this manner, alternative resolutions and/or outcomes can be offered to customers much faster, such as warranty returns (e.g., returning, replacing, or repairing products under warranty), dispatching on-site technicians, and so forth.

In the illustrated embodiment, the CRM system 110 includes a CRM platform 112, a customer case database 114, and an AI case prediction platform 115. In various embodiments, the respective components of CRM system 110 may be implemented on the same computing device/platform or may be distributed across multiple computing devices/platforms that are communicatively coupled (e.g., via an interconnect, switch fabric, local area network, and/or wide area network (e.g., the Internet), among other examples).

The CRM platform 112 may implement various functionality relating to customer relationship management for a business, including customer service and support, sales, business development, recruiting, marketing, and so forth. For example, with respect to customer support, the CRM platform 112 may track the status of customer support cases in a customer case database 114, which may contain a comprehensive collection of information associated with each case.

The AI case prediction platform 115 leverages artificial intelligence (AI) and machine learning (ML) to predictively manage and/or resolve certain customer support cases. In the illustrated embodiment, for example, the AI case prediction platform 115 includes a model training engine 116, a trained case prediction model 117, and a case prediction engine 118.

The model training engine 116 uses machine learning algorithms to train a case prediction model 117 to predict or infer certain information about customer support cases (e.g., case outcomes, potentially fraudulent cases, customer satisfaction levels) based on historical customer data (e.g., past customer support cases, customer surveys, customer sales data).

In some embodiments, for example, the model training engine 116 may generate an optimally trained model using a “brute force” training approach. For example, the model training engine 116 may train numerous machine learning models using many different combinations of machine learning algorithms, data preprocessing steps, selected feature sets (e.g., sets of “features” or fields from closed customer support cases in the case database 114), feature transformations, tuning parameters, and so forth. The model training engine 116 then ranks the models based on various performance metrics (e.g., speed, logarithmic loss, area under the ROC curve (AUC)) and then selects and optimizes the top performing model 117. In this manner, an optimal model 117 is trained with minimal or no human intervention using a brute force search through the numerous possible permutations of training parameters.

In a product warranty use case, for example, the model training engine 116 may use the approach described above to train the case prediction model 117 to predictively determine the outcomes of customer support cases involving product warranties, such as whether they can be resolved through troubleshooting or will require a warranty return/replacement, based on the outcomes of past customer support cases in the case database 114 that have been closed or resolved.

In this manner, the case prediction engine 118 can then use the trained case prediction model 117 to predictively manage customer support cases. For example, the trained case prediction model 117 may be used to proactively identify customer support cases that will likely be unresolvable through live support and/or manual troubleshooting, which allows those types of customer support to be bypassed in favor of alternative resolutions or outcomes, such as warranty returns (e.g., returning, replacing, and/or repairing products covered by warranty).

As a result, this solution reduces throughput time (TPT) of customer support cases (e.g., the overall time required to resolve cases through troubleshooting, warranty returns, and/or other solutions), which reduces customer support costs and increases customer satisfaction, thus producing a significant gain in efficiency. For example, even a target throughput time (TPT) reduction of approximately 5% annually can achieve a significant efficiency gain. Further, reducing the throughput time (TPT) of customer support cases also positively impacts customer CES scores, which increases the likelihood of future purchases from those customers.

Additional functionality and embodiments are described further in connection with the remaining FIGURES. Accordingly, it should be appreciated that AI customer support management system 100 of FIG. 1 may be implemented with any aspects of the example functionality and embodiments described throughout this disclosure.

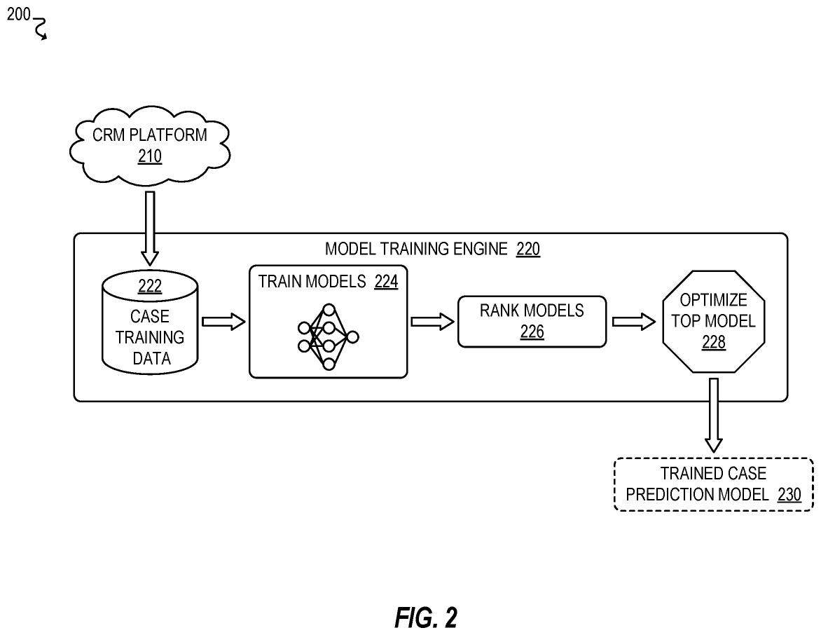

FIGS. 2-4 illustrate an example implementation of an AI customer support case management system for a product warranty use case. In the illustrated example, the AI customer support case management system proactively identifies customer support cases that will likely be resolved through product warranty (e.g., returning, repairing, and/or replacing a product under warranty) rather than through troubleshooting. In this manner, the identified customer support cases can be resolved much faster, as warranty-based resolutions can be offered to customers from the outset without requiring them to perform futile troubleshooting as a prerequisite.

FIG. 2 illustrates an example 200 of model training on the AI customer support case management system. In the illustrated example 200, a model training engine 220 uses machine learning techniques to train a case prediction model 230 to predictively determine whether customer support cases can be resolved through troubleshooting or will require a warranty-based resolution (e.g., returning, repairing, and/or replacing a product under warranty).

The case prediction model 230 is trained using case training data 222 from past customer support cases that have already been closed or resolved. For example, the case training data 222 includes a set of training “features” and “ground truth” labels or outcomes for the past customer support cases. The “features” include various contextual and/or descriptive characteristics of the past customer support cases, while the “ground truth” labels indicate the ultimate outcome of those cases. In some embodiments, for example, the ground truth labels or outcomes may indicate whether the customer support cases were resolved through troubleshooting versus product warranty (e.g., a product return/repair/replacement). In various embodiments and use cases, however, the ground truth labels or outcomes may indicate the resolutions with more specificity or granularity, and/or may indicate other types of resolutions. For example, the ground truth labels or outcomes may indicate whether the customer support cases were resolved through product return, product repair, product replacement, product troubleshooting, product training (e.g., providing additional product training to customers), software updates, and so forth, and optionally an estimated cost of resolving the cases (e.g., indicating the “price” of customer happiness).

In the illustrated example, the case training data 222 is extracted from a customer case database on a CRM platform 210. For example, a business typically tracks a comprehensive collection of information associated with customer support cases, which is often stored in a customer case database on a CRM platform 210. The customer case database typically includes numerous fields that store a wide variety of information for each customer support case, such as various contextual and/or descriptive details for each case and its ultimate outcome or resolution, which may be populated manually by customer support agents and/or automatically by business applications and/or chatbots. Accordingly, the set of “features” and the “ground truth” labels for the case training data 222 can be extracted from the appropriate fields of the customer case database. For example, certain fields corresponding to selected characteristics of past customer support cases (e.g., general subject, product name, description of product/issue, category of product/issue, etc.) can serve as the set of “features,” while other field(s) corresponding to the case outcomes (e.g., whether the cases were resolved through troubleshooting versus product warranty) can serve as the “ground truth” labels.

In some embodiments, the parameters used to train the machine learning (ML) model 230 may be manually determined by a data scientist or engineer (e.g., based on experimentation and analysis), such as which machine learning algorithms to use for training, which fields from the customer case database to use as the training features, and so forth. For example, a data scientist may determine that a model trained using a particular type of machine learning and a particular combination of features from past customer support cases (e.g., product-based features, time-based features, and/or location-based features) yields highly accurate predictions. This manual approach to determining the optimal training parameters, however, can often be tedious and time consuming.

Accordingly, in the illustrated embodiment, the model training engine 220 uses a “brute force” training approach to automatically generate an optimally trained model 230. In some embodiments, for example, the model training engine 220 may support automated cross-validation and testing data splits, automated data preprocessing, automated feature transformation and engineering, automated model selection and parameter tuning, ensembles of models, and automated feature importance ranking, among other functionality.

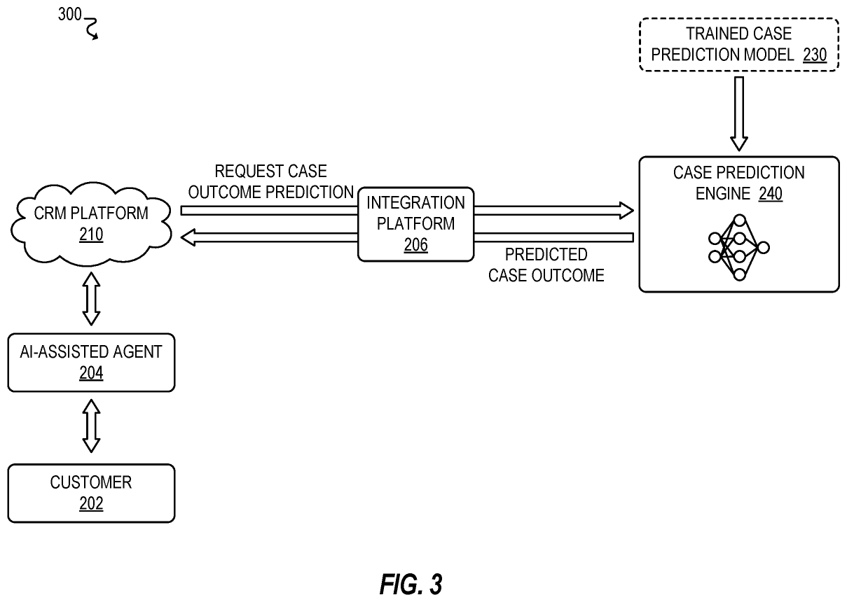

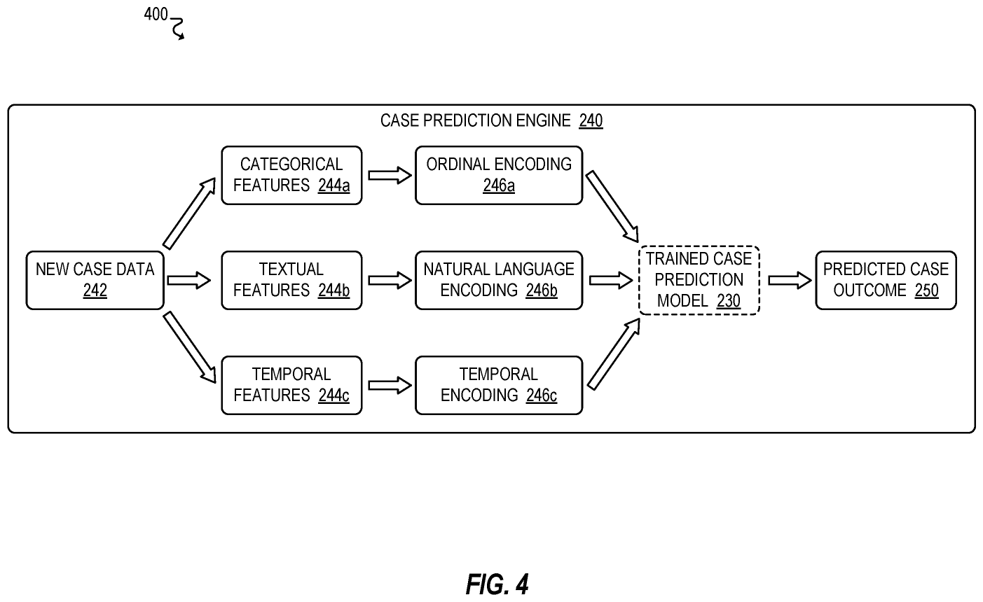

For example, at block 222, data from past customer support cases is obtained from the case database on the CRM platform 210, which will be used as the training data 222. At block 224, numerous machine learning models are then trained using many different combinations of machine learning algorithms, data preprocessing steps, selected feature sets from the training data 222 (e.g., sets of “features” or fields from closed customer support cases in the case database), feature transformations, tuning parameters, and so forth. At block 226, the resulting models are then ranked based on various performance metrics, such as speed, logarithmic loss, area under the receiver operating characteristic (ROC) curve (AUC), and so forth. At block 228, the top-performing model is then selected based on the ranking and is further optimized, which yields an optimally trained case prediction model 230 that can be used to predict the outcome of new or unresolved customer support cases (e.g., as described further in connection with FIGS. 3-4). In this manner, an optimal model 230 is trained with minimal or no human intervention using a brute force search through the numerous possible permutations of training parameters.

Moreover, in some embodiments, the model 230 may be periodically updated (e.g., on a monthly, quarterly, or annual basis) based on new data from the customer support database (e.g., case records for new cases that have been closed/resolved) to calibrate the model to the most up-to-date system status.

With respect to a product warranty use case, for example, the model training engine 220 performs the brute force training approach described above using data from past customer support cases that have been closed or resolved. For example, a data engineering pipeline 222 is provided with a snapshot of customer case data from an early version of the historical case records, which ensures that training is performed using data that will most likely be available at the initial stage of case creation (and thus can be used to predict the outcome of new or unresolved cases). The data engineering pipeline 222 is equipped with automatic data type detection and transformation, which is capable of handling textual, categorical, and temporal (e.g., date/time) features, among others. For example, natural language processing techniques may be applied to process textual features, ordinal encoding may be applied to process categorical features, and any suitable form of temporal encoding may be applied to process temporal features (e.g., cyclical, vectorized, and/or numerical encoding of time and/or date).

A modeling pipeline 224 then searches through millions of possible combinations of data preprocessing steps, feature sets, feature transformations, machine learning algorithms, and tuning parameters. Based on the universe of possible training permutations that are identified, the modeling pipeline 224 trains numerous machine learning models (e.g., using supervised learning algorithms to analyze the data and identify predictive relationships). For example, the models may be trained using a variety of different types and combinations of machine learning algorithms, such as logistic regression, random forest, decision trees, classification and regression trees (CART), gradient boosting (e.g., extreme gradient boosted trees), k-nearest neighbors (kNN), Naïve-Bayes, support vector machines (SVM), and/or ensembles thereof (e.g., models that combine the predictions of multiple machine learning models to improve prediction accuracy), among other examples. Moreover, for the different types and/or combinations of machine learning algorithms, training may be performed using many different combinations of data preprocessing steps, feature sets, feature transformations, tuning parameters, and so forth. For example, the models may be trained using many different combinations of features for past customer support cases, which are obtained from the various fields in the customer case database, along with many different representations, transformations, and/or encodings of those features.

As described above, the resulting models are then ranked based on performance 226 and the top performing model is then chosen and further optimized 228 as the optimal case prediction model 230. In this manner, minimal or no human intervention is needed during the model training and testing process, which makes the model training engine 220 a highly efficient and scalable modeling module.

As an example, this approach has been performed on a snapshot of actual customer case data containing several time-based and product-based features for past customer support cases. For this example, the following seven features—which correspond to fields from the snapshot of customer case data—were finalized in the modeling process based on performance metrics (e.g., log loss, AUC, speed) of the top performing models:
(1) Subject (e.g., general subject area of the issue/product);
(2) Description (e.g., description of the issue/product);
(3) Category (e.g., static/predefined category corresponding to the issue/product);
(4) Category Issue (e.g., description of issue within the category);
(5) Product Name (e.g., name of the product);
(6) Product Life Cycle Status (e.g., whether product is currently supported or end-of-life); and
(7) Contact Center (e.g., location/region of call center or agent).
   Moreover, based on the performance metrics, an extreme gradient boosted tree with early stopping criterion was chosen as the best performing model 230. The early stopping criterion, for example, is a performance optimization that enables the model 230 to avoid reductions in prediction accuracy due to overfitting. In this example, the model 230 consistently achieves 87% or better accuracy with an area under the ROC curve (AUC) score of 0.95.

Once the case prediction model 230 has been trained, it can then be used to predict, infer, and/or classify the outcome of new customer support cases that have not yet been resolved, as described further in connection with FIGS. 3-4.

FIG. 3 illustrates an example 300 of model deployment and integration on the AI customer support case management system. In the illustrated example, the case prediction model 230 from the example of FIG. 2 is deployed and integrated with a CRM case management platform through triggers and application programming interface (API) technology, as described further below.

In the illustrated example, the trained case prediction model 230 is deployed on a case prediction engine 240, which uses the model 230 to predict, infer, and/or classify the outcome of new customer support cases that have not yet been resolved (e.g., predict whether the new cases can be resolved through troubleshooting or will require warranty-based resolutions). Moreover, the case prediction engine 240 is integrated with the CRM platform 210 via an integration platform 206 (e.g., an integration Platform as a Service (iPaaS)).

Further, a trigger is set in the CRM platform 210 when a new case meeting the criteria for prediction is opened. For example, the criteria for prediction may be the opening of a new (unresolved) case that involves a particular product and/or issue. In this manner, when any of the model features or fields from the CRM case record are populated or updated, the CRM platform 210 triggers a request for a case outcome prediction, which passes the case record with the feature data to the case prediction engine 240. In some embodiments, for example, the CRM platform 210 may send an HTTP request containing a JSON payload with a consume class that calls the integration platform service 206, which then passes the case record with the feature data to the case prediction engine 240 via an API endpoint. The case prediction engine 240 then provides the case record as input to the case prediction model 230, which uses the features or fields in the case record to predict the outcome of the case (e.g., as described further in connection with FIG. 4). The case prediction engine 240 then sends the prediction back to the CRM platform 210 via an API call. The CRM platform 210 then stores the prediction in the corresponding case record object and determines the appropriate action to take based on the value of the prediction.

In some embodiments, for example, the prediction value represents the probability or likelihood of the case being resolved through a warranty return rather than through troubleshooting. Moreover, in some embodiments, the prediction value and a recommended action are displayed to an agent 204 via an agent user interface (UI) on the CRM platform 210.

For example, if the prediction value is equal to or above a certain threshold, such as 0.6 or higher (e.g., =>60%), the agent 204 may be directed to immediately process a warranty return for the customer 202. If the prediction value is below a certain threshold, such as under 0.6 (e.g., <60%), the agent 204 may be advised to continue troubleshooting the problem with the customer 202 to solve the case. Alternatively, or additionally, if the prediction value is above a certain threshold, such as 0.8 or higher (e.g., =>80%), a warranty return may be automatically triggered and processed.

Moreover, as the case features are updated in the CRM platform 210 with additional information through troubleshooting or otherwise, the updated values are sent to the model 230 to return a new prediction value and provide updated guidance to the agent 204.

In some embodiments, error handling is implemented to alert technical support if the API call fails or does not return expected data format.

FIG. 4 illustrates an example 400 of model inference on the AI customer support case management system. In particular, the example 400 of FIG. 4 illustrates the functionality of the case prediction engine 240 described above in connection with FIG. 3.

For example, as described above, when a new customer support case is opened in the CRM platform 210, the same collection of features that were used during the training stage are extracted for the new customer support case, and that case data 242 is then fed as input to the case prediction engine 240.

The case data features 242 for the new case can then be processed in a similar manner as those extracted during the training stage. For example, the features extracted for the new case can be separated into categorical features 244a, textual features 244b, and temporal features 244c, among other examples. Categorical features 244a may include features defined based on a set of static/predetermined values or categories (e.g., product type or category, product life cycle, agent contact center), textual features 244b may include features defined based on natural language and/or text values (e.g., product name, subject, and/or description, issue description), and temporal features 244c may include features defined based on dates or times (e.g., dates when cases are opened or when the product issues occurred).

The categorical features 244a, textual features 244b, and temporal features 244c are then separately encoded into numerical representations that can be supplied as input to the case prediction model 230. For example, the categorical features 244a can be encoded using an ordinal encoding scheme 246a, which maps the static/predefined categorical values into corresponding numerical values. The textual features 244b can be encoded using a natural language encoding scheme 246b, which translates the textual values into vector representations. In some embodiments, for example, the textual features 244b may be encoded using a weighted n-gram encoding scheme 246b, which translates the textual values into weighted n-gram vectors, such as vectorized n-grams with term frequency—inverse document frequency (TF-IDF) weighting (e.g., n-gram TF-IDF encoding). Similarly, the temporal features can be encoded using any suitable form of temporal encoding (e.g., cyclical, vectorized, and/or numerical encoding of time and/or date data).

The encoded features 246a-c are then provided as input to the trained case prediction model 230 for the inference or prediction stage. In particular, the case prediction model 230 uses the encoded features 246a-c to generate a prediction 250 regarding the outcome of the new case, such as whether the new case can be resolved through troubleshooting or will require a warranty-based resolution.

If the new case is predicted to require a warranty-based resolution, then the new case can be resolved much faster, as the warranty-based resolution can be offered to the customer from the outset without requiring the customer to manually troubleshoot the issue.

In some embodiments, for example, a customer support agent 204 may be presented with a score indicating the likelihood of a particular case being resolved through troubleshooting, which the agent 204 may use as guidance in deciding whether to troubleshoot the case. For example, many business application suite vendors (e.g., CRM platform vendors) provide APIs to extend the functionality of their offerings, and those APIs could be used to present the likelihood score to the agent via a pop-up window in the application user interface (UI).

As a result, this solution increases overall customer satisfaction, while also decreasing the cost of providing customer support. Moreover, this solution achieves high accuracy for predictions regarding whether customer support cases should be resolved through product warranties versus troubleshooting (e.g., 87% accuracy or higher with an area under the ROC curve (AUC) score of 0.95).

The use case described above in connection with FIGS. 2-4 is merely presented as an example, and in other embodiments, this solution may be adapted for other use cases. For example, in the illustrated embodiment, a particular collection of features is used to train a case prediction model 230 to predict whether to resolve customer support cases through product warranties versus troubleshooting. In other embodiments, however, other types of features may be used to train the model 230 and/or the model 230 may be trained to render other types of predictions (e.g., fraudulent cases, customer satisfaction levels).

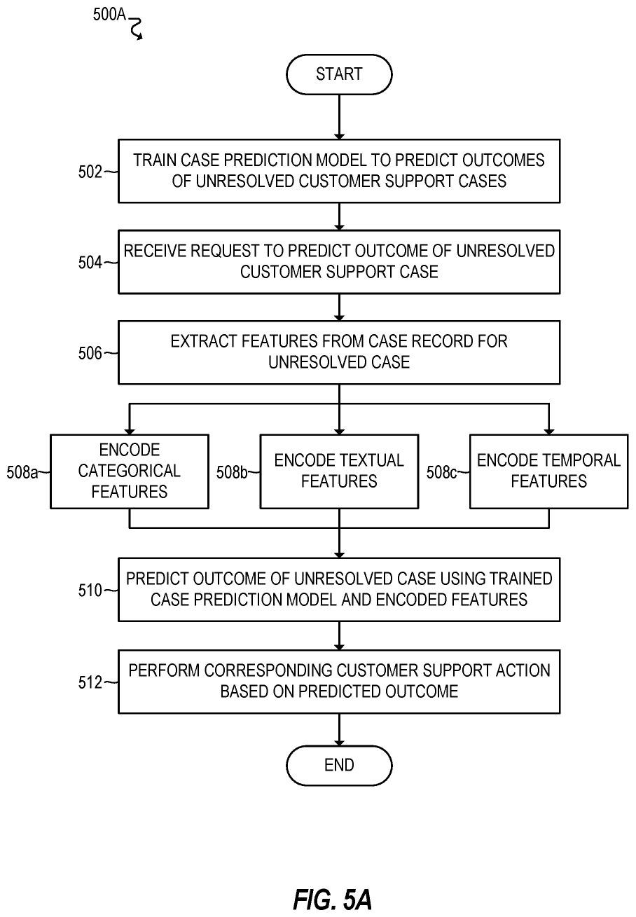

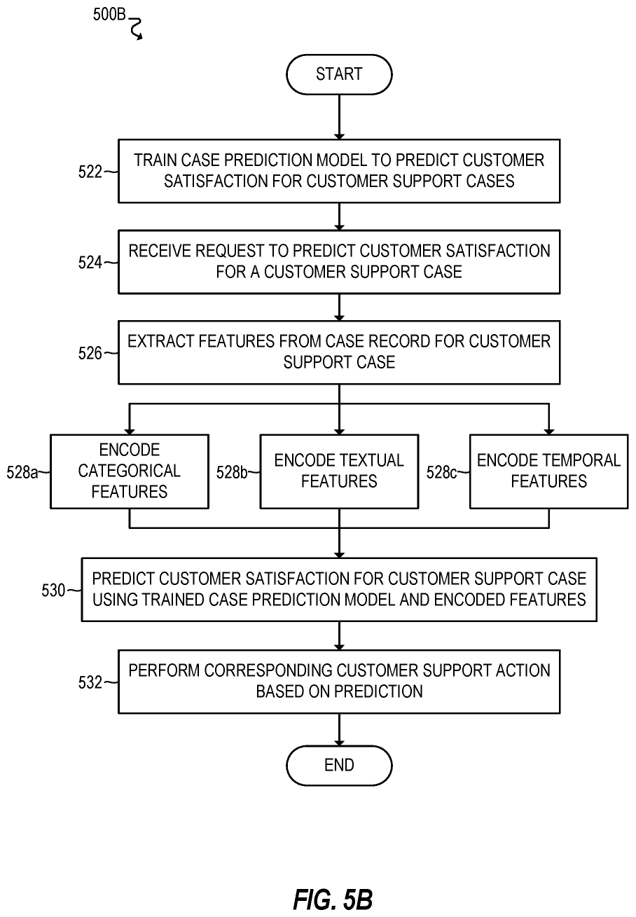

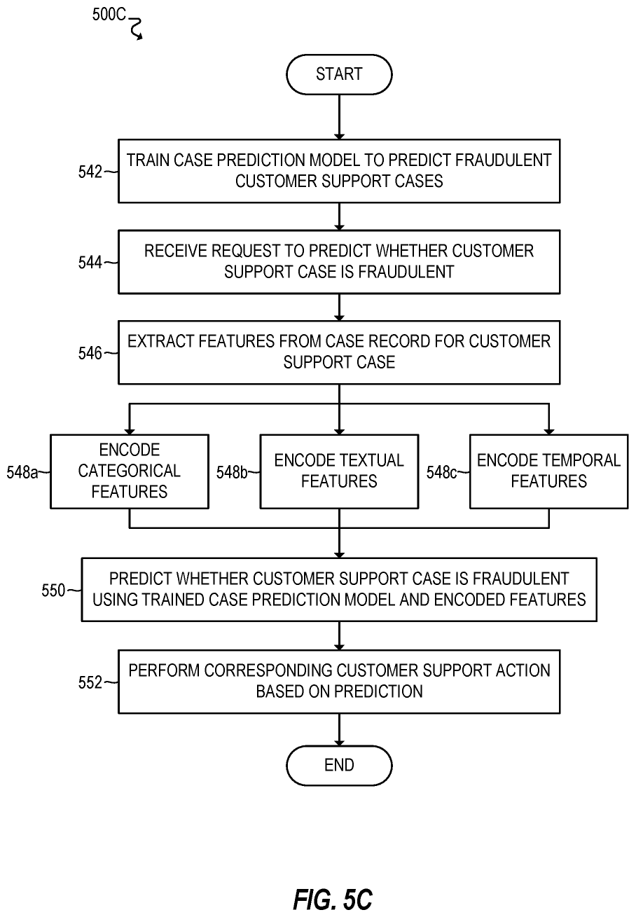

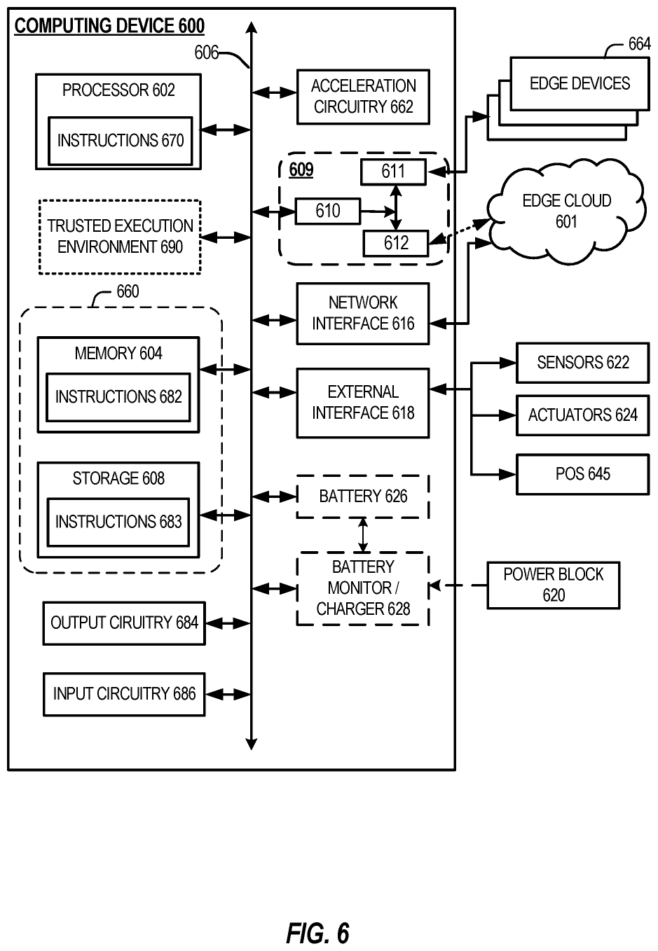

FIG. 5A illustrates a flowchart 500A for predictively resolving customer support cases using artificial intelligence. In some embodiments, flowchart 500A may be implemented and/or performed by the computing systems and devices described throughout this disclosure, such as the AI customer support case management systems of FIGS. 1-4 and/or computing device 600 of FIG. 6.

The flowchart begins at block 502 by training a case prediction model to predict outcomes of unresolved customer support cases. For example, the predicted outcome of an unresolved case may include performing troubleshooting to resolve a problem with a product, or alternatively, replacing the product under a warranty.

In some embodiments, the case prediction model may be trained to predict the outcomes of unresolved cases based on case records for resolved customer support cases. For example, the case prediction model may be trained using machine learning algorithm(s) based on feature set(s) extracted from the case records for the resolved cases along with the ground truth outcomes of the resolved cases. In some embodiments, for example, the feature set from the case records for resolved cases may include a subject, a product name, a product category, a problem or issue category, a problem or issue description, a product life cycle status, and/or a customer service center location, among other possible examples. Moreover, the ground truth outcomes may indicate whether the customer support cases were resolved through troubleshooting versus product warranty (e.g., a product return/repair/replacement). In various embodiments and use cases, however, the ground truth outcomes may indicate the resolutions with more detail or granularity, and/or may indicate other types of resolutions. For example, the ground truth labels or outcomes may indicate whether the customer support cases were resolved through product return, product repair, product replacement, product troubleshooting, product training (e.g., providing additional product training to customers), software updates, and so forth, and optionally an estimated cost of resolving the cases (e.g., indicating the “price” of customer happiness).

Further, in some embodiments, the case prediction model may be trained by: identifying a plurality of possible combinations of training parameters for training the case prediction model to predict the outcomes of unresolved customer support cases; training a plurality of machine learning models based on the plurality of possible combinations of training parameters; computing performance metrics for the plurality of machine learning models; and selecting the case prediction model from the plurality of machine learning models based on the performance metrics. In some embodiments, the performance metrics may include a logarithmic loss metric, an area under a curve metric, and/or a speed metric.

The trained case prediction model may then be stored on storage circuitry or memory circuitry of a computing device.

The flowchart then proceeds to block 504, where a request to predict the outcome of an unresolved customer support case is received. In some embodiments, the request may include a case record corresponding to the unresolved customer support case.

The flowchart then proceeds to block 506 to extract a set of features from the case record for the unresolved case. The set of features extracted from the case record for the unresolved case may include the same features that were extracted from the case records for resolved cases during training of the case prediction model. In some embodiments, for example, the set of features may include a set of categorical features, a set of textual features, and/or a set of temporal features.

The flowchart then proceeds to block 508a-c to separately encode the categorical, textual, and/or temporal features using the appropriate encoding schemes. For example, a set of categorical features may be encoded into a set of encoded categorical features that are represented numerically (e.g., based on an ordinal encoding scheme), a set of textual features may be encoded into a set of encoded textual features that are represented numerically (e.g., based on a natural language encoding scheme), and/or a set of temporal features may be encoded into a set of encoded temporal features that are represented numerically (e.g., based on a temporal encoding scheme).

The flowchart then proceeds to block 510 to predict the outcome of the unresolved case using the trained case prediction model and the encoded features for the unresolved case. For example, the trained case prediction model may generate a predicted outcome for the unresolved case by processing the set of encoded features (e.g., encoded categorical, textual, and/or temporal features) for the unresolved case.

The flowchart then proceeds to block 512 to perform a corresponding customer support action based on predicted outcome. In some embodiments, for example, the corresponding customer support action may include initiating a product replacement upon determining that the predicted outcome comprises replacing the product, notifying a customer support agent of the predicted outcome of the unresolved customer support case, and/or transmitting the predicted outcome of the unresolved customer support case to a customer relationship management (CRM) platform, among other examples.

At this point, the flowchart may be complete. In some embodiments, however, the flowchart may restart and/or certain blocks may be repeated. For example, in some embodiments, the flowchart may restart at block 502 to update the training of the case prediction model and/or continue predicting the outcome of unresolved customer support cases.

FIG. 5B illustrates a flowchart 500B for predicting customer satisfaction for customer support cases using artificial intelligence. In some embodiments, flowchart 500B may be implemented and/or performed by the computing systems and devices described throughout this disclosure, such as the AI customer support case management systems of FIGS. 1-4 and/or computing device 600 of FIG. 6.

The flowchart begins at block 522 by training a case prediction model to predict customer satisfaction levels for customer support cases. In some embodiments, for example, the case prediction model may be trained to predict customer satisfaction based on case records and/or customer surveys for resolved customer support cases. For example, the case prediction model may be trained using machine learning algorithm(s) based on feature set(s) extracted from the case records for the resolved cases along with the ground truth customer satisfaction levels for those cases. The feature set from the case records for resolved cases may include, for example, a subject, a product name, a product category, a problem or issue category, a problem or issue description, a product life cycle status, a customer service center location, and/or a case resolution, among other possible examples. Moreover, the “ground truth” customer satisfaction levels for resolved cases may be obtained from customer surveys and/or other customer/case data that indicates customer satisfaction ratings (e.g., CES scores or other satisfaction ratings such as a 1-10 rating), whether the customers plan to purchase the product again in the future, whether the customers have or would recommend the product to others (e.g., business colleagues, business partners, friends and family, and/or other third parties), whether the customers continued or terminated the business relationship, and so forth.

Further, in some embodiments, the case prediction model may be trained by: identifying a plurality of possible combinations of training parameters for training the case prediction model to predict customer satisfaction for customer support cases; training a plurality of machine learning models based on the plurality of possible combinations of training parameters; computing performance metrics for the plurality of machine learning models; and selecting the case prediction model from the plurality of machine learning models based on the performance metrics. In some embodiments, the performance metrics may include a logarithmic loss metric, an area under a curve metric, and/or a speed metric.

The trained case prediction model may then be stored on storage circuitry or memory circuitry of a computing device.

The flowchart then proceeds to block 524, where a request to predict the customer satisfaction level for a particular customer support case is received. In some embodiments, the request may include a case record and/or other case data corresponding to the customer support case.

The flowchart then proceeds to block 526 to extract a set of features from the case record for the particular case. The set of features extracted from the case record may include the same features that were extracted from the case records during training of the case prediction model. In some embodiments, for example, the set of features may include a set of categorical features, a set of textual features, and/or a set of temporal features.

The flowchart then proceeds to block 528a-c to separately encode the categorical, textual, and/or temporal features using the appropriate encoding schemes. For example, a set of categorical features may be encoded into a set of encoded categorical features that are represented numerically (e.g., based on an ordinal encoding scheme), a set of textual features may be encoded into a set of encoded textual features that are represented numerically (e.g., based on a natural language encoding scheme), and/or a set of temporal features may be encoded into a set of encoded temporal features that are represented numerically (e.g., based on a temporal encoding scheme).

The flowchart then proceeds to block 530 to predict the customer satisfaction level for the particular customer support case using the trained case prediction model and the encoded features for the case. For example, the trained case prediction model may generate a predicted customer satisfaction level for the customer support case by processing the set of encoded features (e.g., encoded categorical, textual, and/or temporal features) for the case.

The flowchart then proceeds to block 532 to perform a corresponding customer support action based on the predicted customer satisfaction level, such as notifying a customer service agent, offering a discount or other inventive to the customer, generating a customer satisfaction report, recommending changes or adjustments to customer support policies, and so forth.

At this point, the flowchart may be complete. In some embodiments, however, the flowchart may restart and/or certain blocks may be repeated. For example, in some embodiments, the flowchart may restart at block 522 to update the training of the case prediction model based on new case data and/or continue predicting customer satisfaction for customer support cases.

FIG. 5C illustrates a flowchart 500C for predicting fraudulent customer support cases using artificial intelligence. In some embodiments, flowchart 500C may be implemented and/or performed by the computing systems and devices described throughout this disclosure, such as the AI customer support case management systems of FIGS. 1-4 and/or computing device 600 of FIG. 6.

The flowchart begins at block 542 by training a case prediction model to predict potentially fraudulent customer support cases. In some embodiments, for example, the case prediction model may be trained to predict fraud based on case records and/or other case data for resolved customer support cases. For example, the case prediction model may be trained using machine learning algorithm(s) based on feature set(s) extracted from the case records for the resolved cases along with ground truth indications of whether those cases were fraudulent. The feature set from the case records for resolved cases may include, for example, a subject, a product name, a product category, a problem or issue category, a problem or issue description, a product life cycle status, a customer service center location, and/or a case resolution, among other possible examples. Moreover, the “ground truth” indications of fraud may indicate whether the cases were determined, suspected, and/or deemed to be fraudulent (e.g., by a customer support agent or other personnel).

Further, in some embodiments, the case prediction model may be trained by: identifying a plurality of possible combinations of training parameters for training the case prediction model to predict fraudulent customer support cases; training a plurality of machine learning models based on the plurality of possible combinations of training parameters; computing performance metrics for the plurality of machine learning models; and selecting the case prediction model from the plurality of machine learning models based on the performance metrics. In some embodiments, the performance metrics may include a logarithmic loss metric, an area under a curve metric, and/or a speed metric.

The trained case prediction model may then be stored on storage circuitry or memory circuitry of a computing device.

The flowchart then proceeds to block 544, where a request to predict whether a particular customer support case is fraudulent is received. In some embodiments, the request may include a case record and/or other case data corresponding to the customer support case.

The flowchart then proceeds to block 546 to extract a set of features from the case record for the particular case. The set of features extracted from the case record may include the same features that were extracted from the case records during training of the case prediction model. In some embodiments, for example, the set of features may include a set of categorical features, a set of textual features, and/or a set of temporal features.

The flowchart then proceeds to block 548a-c to separately encode the categorical, textual, and/or temporal features using the appropriate encoding schemes. For example, a set of categorical features may be encoded into a set of encoded categorical features that are represented numerically (e.g., based on an ordinal encoding scheme), a set of textual features may be encoded into a set of encoded textual features that are represented numerically (e.g., based on a natural language encoding scheme), and/or a set of temporal features may be encoded into a set of encoded temporal features that are represented numerically (e.g., based on a temporal encoding scheme).

The flowchart then proceeds to block 550 to predict whether the particular customer support case is fraudulent using the trained case prediction model and the encoded features for the case. For example, the trained case prediction model may generate a prediction regarding the likelihood of whether the customer support case is fraudulent by processing the set of encoded features (e.g., encoded categorical, textual, and/or temporal features) for the case.

The flowchart then proceeds to block 552 to perform a corresponding customer support action based on the fraud prediction, such as notifying a customer service agent or other business personnel, flagging the case for further investigation, declining a product warranty-based resolution if the case is deemed fraudulent (e.g., declining a product return/repair/replacement request), approving a product warranty-based resolution if the case is not deemed fraudulent (e.g., approving a product return/repair/replacement request), generating a fraud report, recommending changes or adjustments to customer support policies and/or fraud policies, and so forth.

At this point, the flowchart may be complete. In some embodiments, however, the flowchart may restart and/or certain blocks may be repeated. For example, in some embodiments, the flowchart may restart at block 542 to update the training of the case prediction model based on new case data and/or continue predicting potential fraud for customer support cases.

Example Computing Devices, Platforms, and Systems

The following section presents examples of computing devices, platforms, and systems that may be used to implement the AI customer support case management solution described throughout this disclosure.

FIG. 6 illustrates an example computing device or computing platform 600 (also referred to as “system 600,” “device 600,” “appliance 600,” or the like) that may be used in accordance with various embodiments. In embodiments, the platform 600 may be suitable for use in the AI customer support case management systems of FIGS. 1-4, and/or any other element/device discussed herein with regard any other figure shown and described herein. Platform 600 may also be implemented in or as a server computer system or some other element, device, or system discussed herein. The platform 600 may include any combinations of the components shown in the example. The components of platform 600 may be implemented as integrated circuits (ICs), portions thereof, discrete electronic devices, or other modules, logic, hardware, software, firmware, or a combination thereof adapted in the computer platform 600, or as components otherwise incorporated within a chassis of a larger system. The example of FIG. 6 is intended to show a high level view of components of the computer platform 600. However, some of the components shown may be omitted, additional components may be present, and different arrangement of the components shown may occur in other implementations.

The platform 600 includes processor circuitry 602. The processor circuitry 602 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 602 may include one or more hardware accelerators, which may be microprocessors, programmable processing devices (e.g., FPGA, ASIC, etc.), or the like. The one or more hardware accelerators may include, for example, computer vision and/or deep learning accelerators. In some implementations, the processor circuitry 602 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of processor circuitry 602 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, or any suitable combination thereof. The processors (or cores) of the processor circuitry 602 may be coupled with or may include memory/storage and may be configured to execute instructions stored in the memory/storage to enable various applications or operating systems to run on the platform 600. In these embodiments, the processors (or cores) of the processor circuitry 602 is configured to operate application software to provide a specific service to a user of the platform 600. In some embodiments, the processor circuitry 602 may be a special-purpose processor/controller to operate according to the various embodiments herein.

As examples, the processor circuitry 602 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, Calif. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor circuitry 602 may be a part of a system on a chip (SoC), System-in-Package (SiP), a multi-chip package (MCP), and/or the like, in which the processor circuitry 602 and other components are formed into a single integrated circuit, or a single package, such as the Edison™ or Galileo™ SoC boards from Intel® Corporation. Other examples of the processor circuitry 602 are mentioned elsewhere in the present disclosure.

Additionally or alternatively, processor circuitry 602 may include circuitry such as, but not limited to, one or more FPDs such as FPGAs and the like; PLDs such as CPLDs, HCPLDs, and the like; ASICs such as structured ASICs and the like; PSoCs; and the like. In such embodiments, the circuitry of processor circuitry 602 may comprise logic blocks or logic fabric including and other interconnected resources that may be programmed to perform various functions, such as the procedures, methods, functions, etc. of the various embodiments discussed herein. In such embodiments, the circuitry of processor circuitry 602 may include memory cells (e.g., EPROM, EEPROM, flash memory, static memory (e.g., SRAM, anti-fuses, etc.) used to store logic blocks, logic fabric, data, etc. in LUTs and the like.

The processor circuitry 602 may communicate with system memory circuitry 604 over an interconnect 606 (e.g., a bus). Any number of memory devices may be used to provide for a given amount of system memory. As examples, the memory circuitry 604 may be random access memory (RAM) in accordance with a Joint Electron Devices Engineering Council (JEDEC) design such as the DDR or mobile DDR standards (e.g., LPDDR, LPDDR2, LPDDR3, or LPDDR4), dynamic RAM (DRAM), and/or synchronous DRAM (SDRAM)). The memory circuitry 604 may also include nonvolatile memory (NVM) such as high-speed electrically erasable memory (commonly referred to as “flash memory”), phase change RAM (PRAM), resistive memory such as magnetoresistive random access memory (MRAM), etc., and may incorporate three-dimensional (3D) cross-point (XPOINT) memories from Intel® and Micron®. The memory circuitry 604 may also comprise persistent storage devices, which may be temporal and/or persistent storage of any type, including, but not limited to, non-volatile memory, optical, magnetic, and/or solid state mass storage, and so forth.

The individual memory devices of memory circuitry 604 may be implemented as one or more of solder down packaged integrated circuits, socketed memory modules, and plug-in memory cards. The memory circuitry 604 may be implemented as any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs. In embodiments, the memory circuitry 604 may be disposed in or on a same die or package as the processor circuitry 602 (e.g., a same SoC, a same SiP, or soldered on a same MCP as the processor circuitry 602).

To provide for persistent storage of information such as data, applications, operating systems (OS), and so forth, a storage circuitry 608 may also couple to the processor circuitry 602 via the interconnect 606. In an example, the storage circuitry 608 may be implemented via a solid-state disk drive (SSDD). Other devices that may be used for the storage circuitry 608 include flash memory cards, such as SD cards, microSD cards, xD picture cards, and the like, and USB flash drives. In low power implementations, the storage circuitry 608 may be on-die memory or registers associated with the processor circuitry 602. However, in some examples, the storage circuitry 608 may be implemented using a micro hard disk drive (HDD). Further, any number of new technologies may be used for the storage circuitry 608 in addition to, or instead of, the technologies described, such resistance change memories, phase change memories, holographic memories, or chemical memories, among others.

The storage circuitry 608 store computational logic 683 (or “modules 683”) in the form of software, firmware, or hardware commands to implement the techniques described herein. The computational logic 683 may be employed to store working copies and/or permanent copies of computer programs, or data to create the computer programs, for the operation of various components of platform 600 (e.g., drivers, etc.), an OS of platform 600 and/or one or more applications for carrying out the embodiments discussed herein. The computational logic 683 may be stored or loaded into memory circuitry 604 as instructions 682, or data to create the instructions 682, for execution by the processor circuitry 602 to provide the functions described herein. The various elements may be implemented by assembler instructions supported by processor circuitry 602 or high-level languages that may be compiled into such instructions (e.g., instructions 670, or data to create the instructions 670). The permanent copy of the programming instructions may be placed into persistent storage devices of storage circuitry 608 in the factory or in the field through, for example, a distribution medium (not shown), through a communication interface (e.g., from a distribution server (not shown)), or over-the-air (OTA).

In an example, the instructions 682 provided via the memory circuitry 604 and/or the storage circuitry 608 of FIG. 6 are embodied as one or more non-transitory computer readable storage media (see e.g., NTCRSM 660) including program code, a computer program product or data to create the computer program, with the computer program or data, to direct the processor circuitry 602 of platform 600 to perform electronic operations in the platform 600, and/or to perform a specific sequence or flow of actions, for example, as described with respect to the flowchart(s) and block diagram(s) of operations and functionality depicted previously. The processor circuitry 602 accesses the one or more non-transitory computer readable storage media over the interconnect 606.

In alternate embodiments, programming instructions (or data to create the instructions) may be disposed on multiple NTCRSM 660. In alternate embodiments, programming instructions (or data to create the instructions) may be disposed on computer-readable transitory storage media, such as, signals. The instructions embodied by a machine-readable medium may further be transmitted or received over a communications network using a transmission medium via a network interface device utilizing any one of a number of transfer protocols (e.g., HTTP). Any combination of one or more computer usable or computer readable medium(s) may be utilized. The computer-usable or computer-readable medium may be, for example but not limited to, one or more electronic, magnetic, optical, electromagnetic, infrared, or semiconductor systems, apparatuses, devices, or propagation media. For instance, the NTCRSM 660 may be embodied by devices described for the storage circuitry 608 and/or memory circuitry 604. More specific examples (a non-exhaustive list) of a computer-readable medium would include the following: an electrical connection having one or more wires, a portable computer diskette, a hard disk, a random access memory (RAM), a read-only memory (ROM), an erasable programmable read-only memory (EPROM, Flash memory, etc.), an optical fiber, a portable compact disc read-only memory (CD-ROM), an optical storage device and/or optical disks, a transmission media such as those supporting the Internet or an intranet, a magnetic storage device, or any number of other hardware devices. Note that the computer-usable or computer-readable medium could even be paper or another suitable medium upon which the program (or data to create the program) is printed, as the program (or data to create the program) can be electronically captured, via, for instance, optical scanning of the paper or other medium, then compiled, interpreted, or otherwise processed in a suitable manner, if necessary, and then stored in a computer memory (with or without having been staged in or more intermediate storage media). In the context of this document, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (or data to create the program code) embodied therewith, either in baseband or as part of a carrier wave. The computer usable program code (or data to create the program) may be transmitted using any appropriate medium, including but not limited to wireless, wireline, optical fiber cable, RF, etc.

In various embodiments, the program code (or data to create the program code) described herein may be stored in one or more of a compressed format, an encrypted format, a fragmented format, a packaged format, etc. Program code (or data to create the program code) as described herein may require one or more of installation, modification, adaptation, updating, combining, supplementing, configuring, decryption, decompression, unpacking, distribution, reassignment, etc. in order to make them directly readable and/or executable by a computing device and/or other machine. For example, the program code (or data to create the program code) may be stored in multiple parts, which are individually compressed, encrypted, and stored on separate computing devices, wherein the parts when decrypted, decompressed, and combined form a set of executable instructions that implement the program code (the data to create the program code such as that described herein. In another example, the Program code (or data to create the program code) may be stored in a state in which they may be read by a computer, but require addition of a library (e.g., a dynamic link library), a software development kit (SDK), an application programming interface (API), etc. in order to execute the instructions on a particular computing device or other device. In another example, the program code (or data to create the program code) may need to be configured (e.g., settings stored, data input, network addresses recorded, etc.) before the program code (or data to create the program code) can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not co-located in storage or execution location with the instructions enabling the disclosed techniques. Accordingly, the disclosed program code (or data to create the program code) are intended to encompass such machine readable instructions and/or program(s) (or data to create such machine readable instruction and/or programs) regardless of the particular format or state of the machine readable instructions and/or program(s) when stored or otherwise at rest or in transit.

Computer program code for carrying out operations of the present disclosure (e.g., computational logic 683, instructions 682, 670 discussed previously) may be written in any combination of one or more programming languages, including an object oriented programming language such as Python, Ruby, Scala, Smalltalk, Java™, C++, C#, or the like; a procedural programming languages, such as the “C” programming language, the Go (or “Golang”) programming language, or the like; a scripting language such as JavaScript, Server-Side JavaScript (SSJS), JQuery, PHP, Pearl, Python, Ruby on Rails, Accelerated Mobile Pages Script (AMPscript), Mustache Template Language, Handlebars Template Language, Guide Template Language (GTL), PHP, Java and/or Java Server Pages (JSP), Node.js, ASP.NET, JAMscript, and/or the like; a markup language such as Hypertext Markup Language (HTML), Extensible Markup Language (XML), Java Script Object Notion (JSON), Apex®, Cascading Stylesheets (CSS), JavaServer Pages (JSP), MessagePack™, Apache® Thrift, Abstract Syntax Notation One (ASN.1), Google® Protocol Buffers (protobuf), or the like; some other suitable programming languages including proprietary programming languages and/or development tools, or any other languages tools. The computer program code for carrying out operations of the present disclosure may also be written in any combination of the programming languages discussed herein. The program code may execute entirely on the system 600, partly on the system 600, as a stand-alone software package, partly on the system 600 and partly on a remote computer or entirely on the remote computer or server. In the latter scenario, the remote computer may be connected to the system 600 through any type of network, including a LAN or WAN, or the connection may be made to an external computer (e.g., through the Internet using an Internet Service Provider).

In an example, the instructions 670 on the processor circuitry 602 (separately, or in combination with the instructions 682 and/or logic/modules 683 stored in computer-readable storage media) may configure execution or operation of a trusted execution environment (TEE) 690. The TEE 690 operates as a protected area accessible to the processor circuitry 602 to enable secure access to data and secure execution of instructions. In some embodiments, the TEE 690 may be a physical hardware device that is separate from other components of the system 600 such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

In other embodiments, the TEE 690 may be implemented as secure enclaves, which are isolated regions of code and/or data within the processor and/or memory/storage circuitry of the system 600. Only code executed within a secure enclave may access data within the same secure enclave, and the secure enclave may only be accessible using the secure application (which may be implemented by an application processor or a tamper-resistant microcontroller). Various implementations of the TEE 690, and an accompanying secure area in the processor circuitry 602 or the memory circuitry 604 and/or storage circuitry 608 may be provided, for instance, through use of Intel® Software Guard Extensions (SGX), ARM® TrustZone® hardware security extensions, Keystone Enclaves provided by Oasis Labs™, and/or the like. Other aspects of security hardening, hardware roots-of-trust, and trusted or protected operations may be implemented in the device 600 through the TEE 690 and the processor circuitry 602.

In some embodiments, the memory circuitry 604 and/or storage circuitry 608 may be divided into isolated user-space instances such as containers, partitions, virtual environments (VEs), etc. The isolated user-space instances may be implemented using a suitable OS-level virtualization technology such as Docker® containers, Kubernetes® containers, Solaris® containers and/or zones, OpenVZ® virtual private servers, DragonFly BSD® virtual kernels and/or jails, chroot jails, and/or the like. Virtual machines could also be used in some implementations. In some embodiments, the memory circuitry 604 and/or storage circuitry 608 may be divided into one or more trusted memory regions for storing applications or software modules of the TEE 690.

Although the instructions 682 are shown as code blocks included in the memory circuitry 604 and the computational logic 683 is shown as code blocks in the storage circuitry 608, it should be understood that any of the code blocks may be replaced with hardwired circuits, for example, built into an FPGA, ASIC, or some other suitable circuitry. For example, where processor circuitry 602 includes (e.g., FPGA based) hardware accelerators as well as processor cores, the hardware accelerators (e.g., the FPGA cells) may be pre-configured (e.g., with appropriate bit streams) with the aforementioned computational logic to perform some or all of the functions discussed previously (in lieu of employment of programming instructions to be executed by the processor core(s)).

The memory circuitry 604 and/or storage circuitry 608 may store program code of an operating system (OS), which may be a general purpose OS or an OS specifically written for and tailored to the computing platform 600. For example, the OS may be Unix or a Unix-like OS such as Linux e.g., provided by Red Hat Enterprise, Windows10™ provided by Microsoft Corp.®, macOS provided by Apple Inc.®, or the like. In another example, the OS may be a mobile OS, such as Android® provided by Google Inc.®, iOS® provided by Apple Inc.®, Windows 10 Mobile® provided by Microsoft Corp.®, KaiOS provided by KaiOS Technologies Inc., or the like. In another example, the OS may be a real-time OS (RTOS), such as Apache Mynewt provided by the Apache Software Foundation®, Windows 10 For IoT® provided by Microsoft Corp.®, Micro-Controller Operating Systems (“MicroC/OS” or “μC/OS”) provided by Micrium®, Inc., FreeRTOS, VxWorks® provided by Wind River Systems, Inc.®, PikeOS provided by Sysgo AG®, Android Things® provided by Google Inc.®, QNX® RTOS provided by BlackBerry Ltd., or any other suitable RTOS, such as those discussed herein.

The OS may include one or more drivers that operate to control particular devices that are embedded in the platform 600, attached to the platform 600, or otherwise communicatively coupled with the platform 600. The drivers may include individual drivers allowing other components of the platform 600 to interact or control various I/O devices that may be present within, or connected to, the platform 600. For example, the drivers may include a display driver to control and allow access to a display device, a touchscreen driver to control and allow access to a touchscreen interface of the platform 600, sensor drivers to obtain sensor readings of sensor circuitry 621 and control and allow access to sensor circuitry 621, actuator drivers to obtain actuator positions of the actuators 622 and/or control and allow access to the actuators 622, a camera driver to control and allow access to an embedded image capture device, audio drivers to control and allow access to one or more audio devices. The OSs may also include one or more libraries, drivers, APIs, firmware, middleware, software glue, etc., which provide program code and/or software components for one or more applications to obtain and use the data from a secure execution environment, trusted execution environment, and/or management engine of the platform 600 (not shown).

The components may communicate over the IX 606. The IX 606 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, and/or any number of other IX technologies. The IX 606 may be a proprietary bus, for example, used in a SoC based system.

The interconnect 606 couples the processor circuitry 602 to the communication circuitry 609 for communications with other devices. The communication circuitry 609 is a hardware element, or collection of hardware elements, used to communicate over one or more networks (e.g., cloud 601) and/or with other devices (e.g., mesh devices/fog 664). The communication circuitry 609 includes baseband circuitry 610 (or “modem 610”) and RF circuitry 611 and 612.

The baseband circuitry 610 includes one or more processing devices (e.g., baseband processors) to carry out various protocol and radio control functions. Baseband circuitry 610 may interface with application circuitry of platform 600 (e.g., a combination of processor circuitry 602, memory circuitry 604, and/or storage circuitry 608) for generation and processing of baseband signals and for controlling operations of the RF circuitry 611 or 612. The baseband circuitry 610 may handle various radio control functions that enable communication with one or more radio networks via the RF circuitry 611 or 612. The baseband circuitry 610 may include circuitry such as, but not limited to, one or more single-core or multi-core processors (e.g., one or more baseband processors) or control logic to process baseband signals received from a receive signal path of the RF circuitry 611 and/or 612, and to generate baseband signals to be provided to the RF circuitry 611 or 612 via a transmit signal path. In various embodiments, the baseband circuitry 610 may implement an RTOS to manage resources of the baseband circuitry 610, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein.

Although not shown by FIG. 6, in one embodiment, the baseband circuitry 610 includes individual processing device(s) to operate one or more wireless communication protocols (e.g., a “multi-protocol baseband processor” or “protocol processing circuitry”) and individual processing device(s) to implement PHY functions. In this embodiment, the protocol processing circuitry operates or implements various protocol layers/entities of one or more wireless communication protocols. In a first example, the protocol processing circuitry may operate LTE protocol entities and/or 5G)/NR protocol entities when the communication circuitry 609 is a cellular radiofrequency communication system, such as millimeter wave (mmWave) communication circuitry or some other suitable cellular communication circuitry. In the first example, the protocol processing circuitry 602 would operate MAC, RLC, PDCP, SDAP, RRC, and NAS functions. In a second example, the protocol processing circuitry may operate one or more IEEE-based protocols when the communication circuitry 609 is WiFi communication system. In the second example, the protocol processing circuitry would operate WiFi MAC and LLC) functions. The protocol processing circuitry may include one or more memory structures (not shown) to store program code and data for operating the protocol functions, as well as one or more processing cores (not shown) to execute the program code and perform various operations using the data. The protocol processing circuitry provides control functions for the baseband circuitry 610 and/or RF circuitry 611 and 612. The baseband circuitry 610 may also support radio communications for more than one wireless protocol.

Continuing with the aforementioned embodiment, the baseband circuitry 610 includes individual processing device(s) to implement PHY including HARQ functions, scrambling and/or descrambling, (en)coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, radio frequency shifting, and other related functions. etc. The modulation/demodulation functionality may include Fast-Fourier Transform (FFT), precoding, or constellation mapping/demapping functionality. The (en)coding/decoding functionality may include convolution, tail-biting convolution, turbo, Viterbi, or Low Density Parity Check (LDPC) coding. Embodiments of modulation/demodulation and encoder/decoder functionality are not limited to these examples and may include other suitable functionality in other embodiments.

The communication circuitry 609 also includes RF circuitry 611 and 612 to enable communication with wireless networks using modulated electromagnetic radiation through a non-solid medium. Each of the RF circuitry 611 and 612 include a receive signal path, which may include circuitry to convert analog RF signals (e.g., an existing or received modulated waveform) into digital baseband signals to be provided to the baseband circuitry 610. Each of the RF circuitry 611 and 612 also include a transmit signal path, which may include circuitry configured to convert digital baseband signals provided by the baseband circuitry 610 to be converted into analog RF signals (e.g., modulated waveform) that will be amplified and transmitted via an antenna array including one or more antenna elements (not shown). The antenna array may be a plurality of microstrip antennas or printed antennas that are fabricated on the surface of one or more printed circuit boards. The antenna array may be formed in as a patch of metal foil (e.g., a patch antenna) in a variety of shapes, and may be coupled with the RF circuitry 611 or 612 using metal transmission lines or the like.

The RF circuitry 611 (also referred to as a “mesh transceiver”) is used for communications with other mesh or fog devices 664. The mesh transceiver 611 may use any number of frequencies and protocols, such as 2.4 GHz transmissions under the IEEE 802.15.4 standard, using the Bluetooth® low energy (BLE) standard, as defined by the Bluetooth® Special Interest Group, or the ZigBee® standard, among others. Any number of RF circuitry 611, configured for a particular wireless communication protocol, may be used for the connections to the mesh devices 664. For example, a WLAN unit may be used to implement WiFi™ communications in accordance with the IEEE 802.11 standard. In addition, wireless wide area communications, for example, according to a cellular or other wireless wide area protocol, may occur via a WWAN unit.

The mesh transceiver 611 may communicate using multiple standards or radios for communications at different ranges. For example, the platform 600 may communicate with close/proximate devices, e.g., within about 10 meters, using a local transceiver based on BLE, or another low power radio, to save power. More distant mesh devices 664, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

The RF circuitry 612 (also referred to as a “wireless network transceiver,” a “cloud transceiver,” or the like) may be included to communicate with devices or services in the cloud 601 via local or wide area network protocols. The wireless network transceiver 612 includes one or more radios to communicate with devices in the cloud 601. The cloud 601 may be the same or similar to cloud 144 discussed previously. The wireless network transceiver 612 may be a LPWA transceiver that follows the IEEE 802.15.4, or IEEE 802.15.4g standards, among others, such as those discussed herein. The platform 600 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 1002.15.4e specification may be used.

Any number of other radio communications and protocols may be used in addition to the systems mentioned for the mesh transceiver 611 and wireless network transceiver 612, as described herein. For example, the radio transceivers 611 and 612 may include an LTE or other cellular transceiver that uses spread spectrum (SPA/SAS) communications for implementing high-speed communications. Further, any number of other protocols may be used, such as WiFi® networks for medium speed communications and provision of network communications.

The transceivers 611 and 612 may include radios that are compatible with, and/or may operate according to any one or more of the following radio communication technologies and/or standards including but not limited to those discussed herein.

Network interface circuitry/controller (NIC) 616 may be included to provide wired communication to the cloud 601 or to other devices, such as the mesh devices 664 using a standard network interface protocol. The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the platform 600 via NIC 616 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The NIC 616 may include one or more dedicated processors and/or FPGAs to communicate using one or more of the aforementioned network interface protocols. In some implementations, the NIC 616 may include multiple controllers to provide connectivity to other networks using the same or different protocols. For example, the platform 600 may include a first NIC 616 providing communications to the cloud over Ethernet and a second NIC 616 providing communications to other devices over another type of network.

The interconnect 606 may couple the processor circuitry 602 to an external interface 618 (also referred to as “I/O interface circuitry” or the like) that is used to connect external devices or subsystems. The external devices include, inter alia, sensor circuitry 621, actuators 622, and positioning circuitry 645.

The sensor circuitry 621 may include devices, modules, or subsystems whose purpose is to detect events or changes in its environment and send the information (sensor data) about the detected events to some other a device, module, subsystem, etc. Examples of such sensors 621 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

The external interface 618 connects the platform 600 to actuators 622, allow platform 600 to change its state, position, and/or orientation, or move or control a mechanism or system. The actuators 622 comprise electrical and/or mechanical devices for moving or controlling a mechanism or system, and converts energy (e.g., electric current or moving air and/or liquid) into some kind of motion. The actuators 622 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 622 may include one or more electromechanical devices such as pneumatic actuators, hydraulic actuators, electromechanical switches including electromechanical relays (EMRs), motors (e.g., DC motors, stepper motors, servomechanisms, etc.), wheels, thrusters, propellers, claws, clamps, hooks, an audible sound generator, and/or other like electromechanical components. The platform 600 may be configured to operate one or more actuators 622 based on one or more captured events and/or instructions or control signals received from a service provider and/or various client systems.

The positioning circuitry 645 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 645 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 645 may include a Micro-Technology for Positioning, Navigation, and Timing (Micro-PNT) IC that uses a master timing clock to perform position tracking/estimation without GNSS assistance. The positioning circuitry 645 may also be part of, or interact with, the communication circuitry 609 to communicate with the nodes and components of the positioning network. The positioning circuitry 645 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS).

In some implementations, the positioning circuitry 645 is, or includes an INS, which is a system or device that uses sensor circuitry 621 (e.g., motion sensors such as accelerometers, rotation sensors such as gyroscopes, and altimimeters, magentic sensors, and/or the like to continuously calculate (e.g., using dead by dead reckoning, triangulation, or the like) a position, orientation, and/or velocity (including direction and speed of movement) of the platform 600 without the need for external references.

In some examples, various I/O devices may be present within, or connected to, the platform 600, which are referred to as input device circuitry 686 and output device circuitry 684 in FIG. 6. The input device circuitry 686 and output device circuitry 684 include one or more user interfaces designed to enable user interaction with the platform 600 and/or peripheral component interfaces designed to enable peripheral component interaction with the platform 600. Input device circuitry 686 may include any physical or virtual means for accepting an input including, inter alia, one or more physical or virtual buttons (e.g., a reset button), a physical keyboard, keypad, mouse, touchpad, touchscreen, microphones, scanner, headset, and/or the like.

The output device circuitry 684 may be included to show information or otherwise convey information, such as sensor readings, actuator position(s), or other like information. Data and/or graphics may be displayed on one or more user interface components of the output device circuitry 684. Output device circuitry 684 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 600. The output device circuitry 684 may also include speakers or other audio emitting devices, printer(s), and/or the like. In some embodiments, the sensor circuitry 621 may be used as the input device circuitry 686 (e.g., an image capture device, motion capture device, or the like) and one or more actuators 622 may be used as the output device circuitry 684 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

A battery 624 may be coupled to the platform 600 to power the platform 600, which may be used in embodiments where the platform 600 is not in a fixed location. The battery 624 may be a lithium ion battery, a lead-acid automotive battery, or a metal-air battery, such as a zinc-air battery, an aluminum-air battery, a lithium-air battery, a lithium polymer battery, and/or the like. In embodiments where the platform 600 is mounted in a fixed location, the platform 600 may have a power supply coupled to an electrical grid. In these embodiments, the platform 600 may include power tee circuitry to provide for electrical power drawn from a network cable to provide both power supply and data connectivity to the platform 600 using a single cable.

PMIC 626 may be included in the platform 600 to track the state of charge (SoCh) of the battery 624, and to control charging of the platform 600. The PMIC 626 may be used to monitor other parameters of the battery 624 to provide failure predictions, such as the state of health (SoH) and the state of function (SoF) of the battery 624. The PMIC 626 may include voltage regulators, surge protectors, power alarm detection circuitry. The power alarm detection circuitry may detect one or more of brown out (under-voltage) and surge (over-voltage) conditions. The PMIC 626 may communicate the information on the battery 624 to the processor circuitry 602 over the interconnect 606. The PMIC 626 may also include an analog-to-digital (ADC) convertor that allows the processor circuitry 602 to directly monitor the voltage of the battery 624 or the current flow from the battery 624. The battery parameters may be used to determine actions that the platform 600 may perform, such as transmission frequency, mesh network operation, sensing frequency, and the like. As an example, the PMIC 626 may be a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex.

A power block 628, or other power supply coupled to a grid, may be coupled with the PMIC 626 to charge the battery 624. In some examples, the power block 628 may be replaced with a wireless power receiver to obtain the power wirelessly, for example, through a loop antenna in the platform 600. A wireless battery charging circuit, such as an LTC4020 chip from Linear Technologies of Milpitas, Calif., among others, may be included in the PMIC 626. The specific charging circuits chosen depend on the size of the battery 624, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a computing device for predicting outcomes of unresolved customer support cases, comprising: storage circuitry to store a trained case prediction model, wherein the trained case prediction model is trained to predict outcomes of unresolved customer support cases based on case records for resolved customer support cases; and processing circuitry to: receive a request to predict an outcome of an unresolved customer support case, wherein the request comprises a case record corresponding to the unresolved customer support case; extract, from the case record, a set of features corresponding to the unresolved customer support case, wherein the set of features comprises a set of categorical features and a set of textual features; encode the set of categorical features into a set of encoded categorical features based on an ordinal encoding scheme, wherein the set of encoded categorical features is to be represented numerically; encode the set of textual features into a set of encoded textual features based on a natural language encoding scheme, wherein the set of encoded textual features is to be represented numerically; predict the outcome of the unresolved customer support case using the trained case prediction model, wherein the trained case prediction model is to generate a predicted outcome for the unresolved customer support case based on the set of encoded categorical features and the set of encoded textual features; and perform a corresponding customer support action based on the predicted outcome of the unresolved customer support case.

Example 2 includes the computing device of Example 1, wherein the processing circuitry is further to: train the case prediction model to predict the outcomes of unresolved customer support cases, wherein the case prediction model is to be trained using a machine learning algorithm based on: a feature set extracted from the case records for resolved customer support cases; and ground truth outcomes of the resolved customer support cases.

Example 3 includes the computing device of Example 2, wherein the feature set extracted from the case records for resolved customer support cases comprises: a product name; a product category; a problem description; and a product life cycle status.

Example 4 includes the computing device of Example 2, wherein the processing circuitry to train the case prediction model to predict the outcomes of unresolved customer support cases is further to: identify a plurality of possible combinations of training parameters for training the case prediction model to predict the outcomes of unresolved customer support cases; train a plurality of machine learning models based on the plurality of possible combinations of training parameters; compute performance metrics for the plurality of machine learning models; and select the case prediction model from the plurality of machine learning models based on the performance metrics.

Example 5 includes the computing device of Example 4, wherein the performance metrics comprise: a logarithmic loss metric; an area under a curve metric; and a speed metric.

Example 6 includes the computing device of Example 1, wherein the predicted outcome of the unresolved customer support case comprises: performing troubleshooting to resolve a problem with a product; or replacing the product.

Example 7 includes the computing device of Example 6, wherein the processing circuitry to perform the corresponding customer support action based on the predicted outcome of the unresolved customer support case is further to: initiate a product replacement upon determining that the predicted outcome comprises replacing the product.

Example 8 includes the computing device of Example 6, wherein the processing circuitry to perform the corresponding customer support action based on the predicted outcome of the unresolved customer support case is further to: notify a customer support agent of the predicted outcome of the unresolved customer support case; or transmit the predicted outcome of the unresolved customer support case to a customer relationship management (CRM) platform.

Example 9 includes at least one non-transitory machine-readable storage medium having instructions stored thereon, wherein the instructions, when executed on processing circuitry of a computing device, cause the processing circuitry to: receive, via interface circuitry, a request to predict an outcome of an unresolved customer support case, wherein the request comprises a case record corresponding to the unresolved customer support case; extract, from the case record, a set of features corresponding to the unresolved customer support case, wherein the set of features comprises a set of categorical features and a set of textual features; encode the set of categorical features into a set of encoded categorical features based on an ordinal encoding scheme, wherein the set of encoded categorical features is to be represented numerically; encode the set of textual features into a set of encoded textual features based on a natural language encoding scheme, wherein the set of encoded textual features is to be represented numerically; predict the outcome of the unresolved customer support case using a trained case prediction model, wherein the trained case prediction model is to generate a predicted outcome for the unresolved customer support case based on the set of encoded categorical features and the set of encoded textual features; and perform a corresponding customer support action based on the predicted outcome of the unresolved customer support case.

Example 10 includes the storage medium of Example 9, wherein the instructions further cause the processing circuitry to: train the case prediction model to predict outcomes of unresolved customer support cases, wherein the case prediction model is to be trained using a machine learning algorithm based on: a feature set extracted from the case records for resolved customer support cases; and ground truth outcomes of the resolved customer support cases.

Example 11 includes the storage medium of Example 10, wherein the feature set extracted from the case records for resolved customer support cases comprises: a product name; a product category; a problem description; and a product life cycle status.

Example 12 includes the storage medium of Example 10, wherein the instructions that cause the processing circuitry to train the case prediction model to predict the outcomes of unresolved customer support cases further cause the processing circuitry to: identify a plurality of possible combinations of training parameters for training the case prediction model to predict the outcomes of unresolved customer support cases; train a plurality of machine learning models based on the plurality of possible combinations of training parameters; compute performance metrics for the plurality of machine learning models; and select the case prediction model from the plurality of machine learning models based on the performance metrics.

Example 13 includes the storage medium of Example 12, wherein the performance metrics comprise: a logarithmic loss metric; an area under a curve metric; and a speed metric.

Example 14 includes the storage medium of Example 9, wherein the predicted outcome of the unresolved customer support case comprises: performing troubleshooting to resolve a problem with a product; or replacing the product.

Example 15 includes the storage medium of Example 14, wherein the instructions that cause the processing circuitry to perform the corresponding customer support action based on the predicted outcome of the unresolved customer support case further cause the processing circuitry to: initiate a product replacement upon determining that the predicted outcome comprises replacing the product.

Example 16 includes the storage medium of Example 14, wherein the instructions that cause the processing circuitry to perform the corresponding customer support action based on the predicted outcome of the unresolved customer support case further cause the processing circuitry to: notify a customer support agent of the predicted outcome of the unresolved customer support case; or transmit the predicted outcome of the unresolved customer support case to a customer relationship management (CRM) platform.

Example 17 includes a method for predicting outcomes of unresolved customer support cases, comprising: receiving, via interface circuitry, a request to predict an outcome of an unresolved customer support case, wherein the request comprises a case record corresponding to the unresolved customer support case; extracting, from the case record, a set of features corresponding to the unresolved customer support case, wherein the set of features comprises a set of categorical features and a set of textual features; encoding the set of categorical features into a set of encoded categorical features based on an ordinal encoding scheme, wherein the set of encoded categorical features is to be represented numerically; encoding the set of textual features into a set of encoded textual features based on a natural language encoding scheme, wherein the set of encoded textual features is to be represented numerically; predicting the outcome of the unresolved customer support case using a trained case prediction model, wherein the trained case prediction model is to generate a predicted outcome for the unresolved customer support case based on the set of encoded categorical features and the set of encoded textual features; and performing a corresponding customer support action based on the predicted outcome of the unresolved customer support case.

Example 18 includes the method of Example 17, further comprising: training the case prediction model to predict outcomes of unresolved customer support cases, wherein the case prediction model is to be trained using a machine learning algorithm based on: a feature set extracted from the case records for resolved customer support cases; and ground truth outcomes of the resolved customer support cases.

Example 19 includes the method of Example 18, wherein the feature set extracted from the case records for resolved customer support cases comprises: a product name; a product category; a problem description; and a product life cycle status.

Example 20 includes the method of Example 18, wherein training the case prediction model to predict the outcomes of unresolved customer support cases comprises: identifying a plurality of possible combinations of training parameters for training the case prediction model to predict the outcomes of unresolved customer support cases; training a plurality of machine learning models based on the plurality of possible combinations of training parameters; computing performance metrics for the plurality of machine learning models; and selecting the case prediction model from the plurality of machine learning models based on the performance metrics.

Example 21 includes the method of Example 20, wherein the performance metrics comprise: a logarithmic loss metric; an area under a curve metric; and a speed metric.

Example 22 includes the method of Example 17, wherein the predicted outcome of the unresolved customer support case comprises: performing troubleshooting to resolve a problem with a product; or replacing the product.

Example 23 includes the method of Example 22, wherein performing the corresponding customer support action based on the predicted outcome of the unresolved customer support case comprises: initiating a product replacement upon determining that the predicted outcome comprises replacing the product.

Example 24 includes the method of Example 22, wherein performing the corresponding customer support action based on the predicted outcome of the unresolved customer support case comprises: notifying a customer support agent of the predicted outcome of the unresolved customer support case; or transmitting the predicted outcome of the unresolved customer support case to a customer relationship management (CRM) platform.

Example 25 includes a system for predicting outcomes of unresolved customer support cases, comprising: means for receiving a request to predict an outcome of an unresolved customer support case, wherein the request comprises a case record corresponding to the unresolved customer support case; means for extracting, from the case record, a set of features corresponding to the unresolved customer support case, wherein the set of features comprises a set of categorical features and a set of textual features; means for encoding the set of categorical features into a set of encoded categorical features based on an ordinal encoding scheme, wherein the set of encoded categorical features is to be represented numerically; means for encoding the set of textual features into a set of encoded textual features based on a natural language encoding scheme, wherein the set of encoded textual features is to be represented numerically; means for predicting the outcome of the unresolved customer support case using a trained case prediction model, wherein the trained case prediction model is to generate a predicted outcome for the unresolved customer support case based on the set of encoded categorical features and the set of encoded textual features; and means for performing a corresponding customer support action based on the predicted outcome of the unresolved customer support case.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A computing device for predicting outcomes of unresolved customer support cases, comprising:
storage circuitry to store a trained case prediction model, wherein the trained case prediction model is trained to predict outcomes of unresolved customer support cases based on case records for resolved customer support cases; and
processing circuitry to:
receive a request to predict an outcome of an unresolved customer support case, wherein the request comprises a case record corresponding to the unresolved customer support case;
extract, from the case record, a set of features corresponding to the unresolved customer support case, wherein the set of features comprises a set of categorical features and a set of textual features;
encode the set of categorical features into a set of encoded categorical features based on an ordinal encoding scheme, wherein the set of encoded categorical features is to be represented numerically;
encode the set of textual features into a set of encoded textual features based on a natural language encoding scheme, wherein the set of encoded textual features is to be represented numerically;
predict the outcome of the unresolved customer support case using the trained case prediction model, wherein the trained case prediction model is to generate a predicted outcome for the unresolved customer support case based on the set of encoded categorical features and the set of encoded textual features; and
perform a corresponding customer support action based on the predicted outcome of the unresolved customer support case.

2. The computing device of claim 1, wherein the processing circuitry is further to:
train the case prediction model to predict the outcomes of unresolved customer support cases, wherein the case prediction model is to be trained using a machine learning algorithm based on:
a feature set extracted from the case records for resolved customer support cases; and
ground truth outcomes of the resolved customer support cases.

3. The computing device of claim 2, wherein the feature set extracted from the case records for resolved customer support cases comprises:
a product name;
a product category;
a problem description; and
a product life cycle status.

4. The computing device of claim 2, wherein the processing circuitry to train the case prediction model to predict the outcomes of unresolved customer support cases is further to:
identify a plurality of possible combinations of training parameters for training the case prediction model to predict the outcomes of unresolved customer support cases;
train a plurality of machine learning models based on the plurality of possible combinations of training parameters;
compute performance metrics for the plurality of machine learning models; and
select the case prediction model from the plurality of machine learning models based on the performance metrics.

5. The computing device of claim 4, wherein the performance metrics comprise:
a logarithmic loss metric;
an area under a curve metric; and
a speed metric.

6. The computing device of claim 1, wherein the predicted outcome of the unresolved customer support case comprises:
performing troubleshooting to resolve a problem with a product; or
replacing the product.

7. The computing device of claim 6, wherein the processing circuitry to perform the corresponding customer support action based on the predicted outcome of the unresolved customer support case is further to:
initiate a product replacement upon determining that the predicted outcome comprises replacing the product.

8. The computing device of claim 6, wherein the processing circuitry to perform the corresponding customer support action based on the predicted outcome of the unresolved customer support case is further to:
notify a customer support agent of the predicted outcome of the unresolved customer support case; or
transmit the predicted outcome of the unresolved customer support case to a customer relationship management (CRM) platform.

9. At least one non-transitory machine-readable storage medium having instructions stored thereon, wherein the instructions, when executed on processing circuitry of a computing device, cause the processing circuitry to:
receive, via interface circuitry, a request to predict an outcome of an unresolved customer support case, wherein the request comprises a case record corresponding to the unresolved customer support case;
extract, from the case record, a set of features corresponding to the unresolved customer support case, wherein the set of features comprises a set of categorical features and a set of textual features;
encode the set of categorical features into a set of encoded categorical features based on an ordinal encoding scheme, wherein the set of encoded categorical features is to be represented numerically;
encode the set of textual features into a set of encoded textual features based on a natural language encoding scheme, wherein the set of encoded textual features is to be represented numerically;
predict the outcome of the unresolved customer support case using a trained case prediction model, wherein the trained case prediction model is to generate a predicted outcome for the unresolved customer support case based on the set of encoded categorical features and the set of encoded textual features; and
perform a corresponding customer support action based on the predicted outcome of the unresolved customer support case.

10. The storage medium of claim 9, wherein the instructions further cause the processing circuitry to:
train the case prediction model to predict outcomes of unresolved customer support cases, wherein the case prediction model is to be trained using a machine learning algorithm based on:
a feature set extracted from the case records for resolved customer support cases; and
ground truth outcomes of the resolved customer support cases.

11. The storage medium of claim 10, wherein the feature set extracted from the case records for resolved customer support cases comprises:
a product name;
a product category;
a problem description; and
a product life cycle status.

12. The storage medium of claim 10, wherein the instructions that cause the processing circuitry to train the case prediction model to predict the outcomes of unresolved customer support cases further cause the processing circuitry to:
identify a plurality of possible combinations of training parameters for training the case prediction model to predict the outcomes of unresolved customer support cases;
train a plurality of machine learning models based on the plurality of possible combinations of training parameters;
compute performance metrics for the plurality of machine learning models; and
select the case prediction model from the plurality of machine learning models based on the performance metrics.

13. The storage medium of claim 12, wherein the performance metrics comprise:
a logarithmic loss metric;
an area under a curve metric; and
a speed metric.

14. The storage medium of claim 9, wherein the predicted outcome of the unresolved customer support case comprises:
performing troubleshooting to resolve a problem with a product; or
replacing the product.

15. The storage medium of claim 14, wherein the instructions that cause the processing circuitry to perform the corresponding customer support action based on the predicted outcome of the unresolved customer support case further cause the processing circuitry to:
initiate a product replacement upon determining that the predicted outcome comprises replacing the product.

16. The storage medium of claim 14, wherein the instructions that cause the processing circuitry to perform the corresponding customer support action based on the predicted outcome of the unresolved customer support case further cause the processing circuitry to:
notify a customer support agent of the predicted outcome of the unresolved customer support case; or
transmit the predicted outcome of the unresolved customer support case to a customer relationship management (CRM) platform.

17. A method for predicting outcomes of unresolved customer support cases, comprising:
receiving, via interface circuitry, a request to predict an outcome of an unresolved customer support case, wherein the request comprises a case record corresponding to the unresolved customer support case;
extracting, from the case record, a set of features corresponding to the unresolved customer support case, wherein the set of features comprises a set of categorical features and a set of textual features;
encoding the set of categorical features into a set of encoded categorical features based on an ordinal encoding scheme, wherein the set of encoded categorical features is to be represented numerically;
encoding the set of textual features into a set of encoded textual features based on a natural language encoding scheme, wherein the set of encoded textual features is to be represented numerically;
predicting the outcome of the unresolved customer support case using a trained case prediction model, wherein the trained case prediction model is to generate a predicted outcome for the unresolved customer support case based on the set of encoded categorical features and the set of encoded textual features; and
performing a corresponding customer support action based on the predicted outcome of the unresolved customer support case.

18. The method of claim 17, further comprising:
training the case prediction model to predict outcomes of unresolved customer support cases, wherein the case prediction model is to be trained using a machine learning algorithm based on:
a feature set extracted from the case records for resolved customer support cases; and
ground truth outcomes of the resolved customer support cases.

19. The method of claim 18, wherein the feature set extracted from the case records for resolved customer support cases comprises:
a product name;
a product category;
a problem description; and
a product life cycle status.

20. The method of claim 18, wherein training the case prediction model to predict the outcomes of unresolved customer support cases comprises:
identifying a plurality of possible combinations of training parameters for training the case prediction model to predict the outcomes of unresolved customer support cases;
training a plurality of machine learning models based on the plurality of possible combinations of training parameters;
computing performance metrics for the plurality of machine learning models; and
selecting the case prediction model from the plurality of machine learning models based on the performance metrics.

21. The method of claim 20, wherein the performance metrics comprise:
a logarithmic loss metric;
an area under a curve metric; and
a speed metric.

22. The method of claim 17, wherein the predicted outcome of the unresolved customer support case comprises:
performing troubleshooting to resolve a problem with a product; or
replacing the product.

23. The method of claim 22, wherein performing the corresponding customer support action based on the predicted outcome of the unresolved customer support case comprises:
initiating a product replacement upon determining that the predicted outcome comprises replacing the product.

24. The method of claim 22, wherein performing the corresponding customer support action based on the predicted outcome of the unresolved customer support case comprises:
notifying a customer support agent of the predicted outcome of the unresolved customer support case; or
transmitting the predicted outcome of the unresolved customer support case to a customer relationship management (CRM) platform.

25. A system for predicting outcomes of unresolved customer support cases, comprising:
means for receiving a request to predict an outcome of an unresolved customer support case, wherein the request comprises a case record corresponding to the unresolved customer support case;
means for extracting, from the case record, a set of features corresponding to the unresolved customer support case, wherein the set of features comprises a set of categorical features and a set of textual features;
means for encoding the set of categorical features into a set of encoded categorical features based on an ordinal encoding scheme, wherein the set of encoded categorical features is to be represented numerically;
means for encoding the set of textual features into a set of encoded textual features based on a natural language encoding scheme, wherein the set of encoded textual features is to be represented numerically;
means for predicting the outcome of the unresolved customer support case using a trained case prediction model, wherein the trained case prediction model is to generate a predicted outcome for the unresolved customer support case based on the set of encoded categorical features and the set of encoded textual features; and
means for performing a corresponding customer support action based on the predicted outcome of the unresolved customer support case.
